(19) United States
(12) Patent Application Publication
(10) Pub. No.: US 2004/0069085 A1
(43) Pub. Date: Apr. 15, 2004

(54) Vibration-proof structure for a gear transmission device

(76) Inventors: Kenichiro Nakamura, Saitama (JP); Satoshi Fujikawa, Saitama (JP); Akira Sonobata, Saitama (JP); Shunsuke Iwai, Saitama (JP)

Correspondence Address: BIRCH STEWART KOLASCH & BIRCH, PO BOX 747, FALLS CHURCH, VA, 22040-0747, US

(21) Appl. No.: 10/646,704

(22) Filed: Aug. 25, 2003

(30) Foreign Application Priority Data
Sep. 11, 2002 (JP) 2002-265194

(51) Int. Cl. F16H 55/14

(52) U.S. Cl. 74/443

(57) ABSTRACT

A vibration-proof structure for a gear transmission device includes a wave washer for pressing a gear of a gear transmission device that can move in an axial direction between opposed first and second fixed walls toward the first fixed wall. The wave washer is interposed between the gear and the second fixed wall. A cylindrical portion surrounding the wave washer is provided between one of the opposed end faces of the gear and the second fixed wall, and the cylindrical portion is in contact with the other end face to regulate an increase in the bending amount of the wave washer of a predetermined value. When the gear of the gear transmission device experiences vibration, the excessive bending of the wave washer for absorbing the vibration is restrained so that the wave washer can always exhibit a normal buffering function.

### CROSS-REFERENCES TO RELATED APPLICATIONS

### BACKGROUND OF THE INVENTION

This nonprovisional application claims priority under 35 U.S.C. § 119(a) on Patent Application No. 2002-265194 filed in Japan on Sep. 11, 2002, the entirety of which is herein incorporated by reference.

1. Field of the Invention

The present invention relates to a vibration-proof structure for a gear transmission device, and more specifically to an improved vibration-proof structure having an elastic member for pressing a gear of the gear transmission device that can move in an axial direction between opposed first and second fixed walls toward the first fixed wall. The vibration of the gear is absorbed by the buffering action of this elastic member.

2. Description of the Background Art

A vibration-proof structure for the above-described gear transmission device has been shown and described in Japanese Patent Application No. 57-171420 and Japanese Patent Application No. 5-79095.

In the vibration-proof structure of a conventional gear transmission device of the background art, an elastic member is interposed between a gear and a second fixed wall simply by applying a predetermined set load. The inventors of the present invention have found that when a large thrust load toward the second fixed wall is applied during operation of the gear, the elastic member may bend excessively and the resiliency of the elastic member becomes excessive. Accordingly, the vibration of the gear is amplified and the service life of the elastic member is impaired.

### SUMMARY OF THE INVENTION

The present invention overcomes the shortcomings associated with the background art and achieves other advantages not realized by the background art.

An object of the present invention is to provide a vibration-proof structure for the above-described gear transmission device.

An additional object of the present invention is to provide a vibration-proof structure that restrains the excessive bending of the elastic member when a gear vibrates so that the elastic member always exhibit a normal buffering function and the durability of the elastic member can be improved.

One or more of these and other objects are accomplished by a gear transmission device comprising a pair of first and second fixed walls, the first and second fixed walls opposing each other with respect to an axial direction of a first gear shaft; a first gear positioned on the first gear shaft between the first and second fixed walls, the first gear being axially moveable with respect to the first and second fixed walls; a vibration-reducing structure having an elastic member being positioned between the first gear and the second fixed wall; and a regulating device for regulating an increase of a bending amount of the elastic member being interposed between the first gear and the second fixed wall by a predetermined value.

According to this first feature, when the gear vibrates in the axial direction between the first and second fixed walls by load variation or the like during the operation of the gear transmission device, the vibration can be absorbed by the bending of the elastic member and when the gear is pressed toward the second fixed wall by a large thrust load, the regulating device regulates the bending amount of the elastic member to suppress the generation of excessive resiliency, thereby making it possible to prevent the amplification of the vibration of a gear, e.g., an idle gear, caused by the excessive resiliency and to improve the durability of the elastic member.

The second feature of the present invention is that the regulating device is constructed by providing a cylindrical portion surrounding the elastic member on one of the opposed end faces of the gear and the second fixed wall and contacting it to the other end face to regulate an increase of a predetermined value or more in the bending amount of the elastic member.

According to this second feature, the regulating device can be constructed with an extremely simple structure that the cylindrical portion is provided on one of the opposed end faces of the gear and the second fixed wall, thereby making it possible to provide an inexpensive vibration-proof structure for a gear transmission device.

Further, another feature of the present invention is that the gear is an idle gear supported by a shaft between the first and second fixed walls in such a manner that it can slide and turn freely. Accordingly, the vibration of the whole gear transmission device can be restrained by suppressing the vibration of the idle gear.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 is a longitudinal sectional view of a starting gear transmission device having a vibration-proof structure according to the present invention;

FIG. 2 is an enlarged view of a vibration-proof structure in the above starting gear transmission device; and

FIG. 3 is a plan view of a wave washer in the vibration-proof structure of the present invention.

### DETAILED DESCRIPTION OF THE PREFERRED EMBODIMENTS

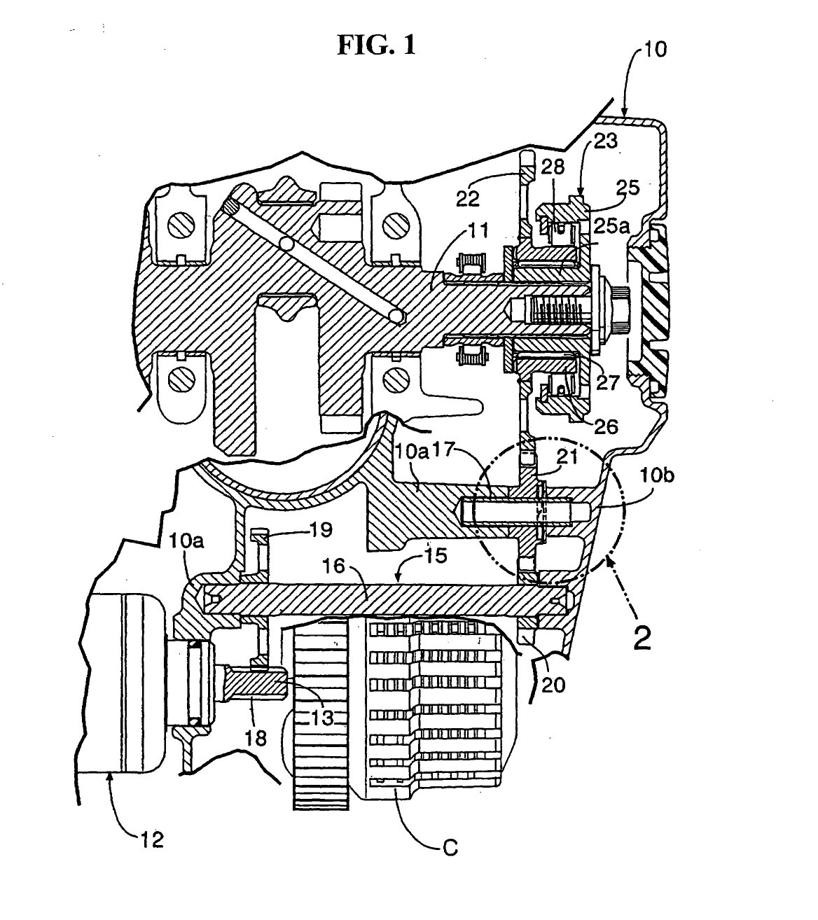

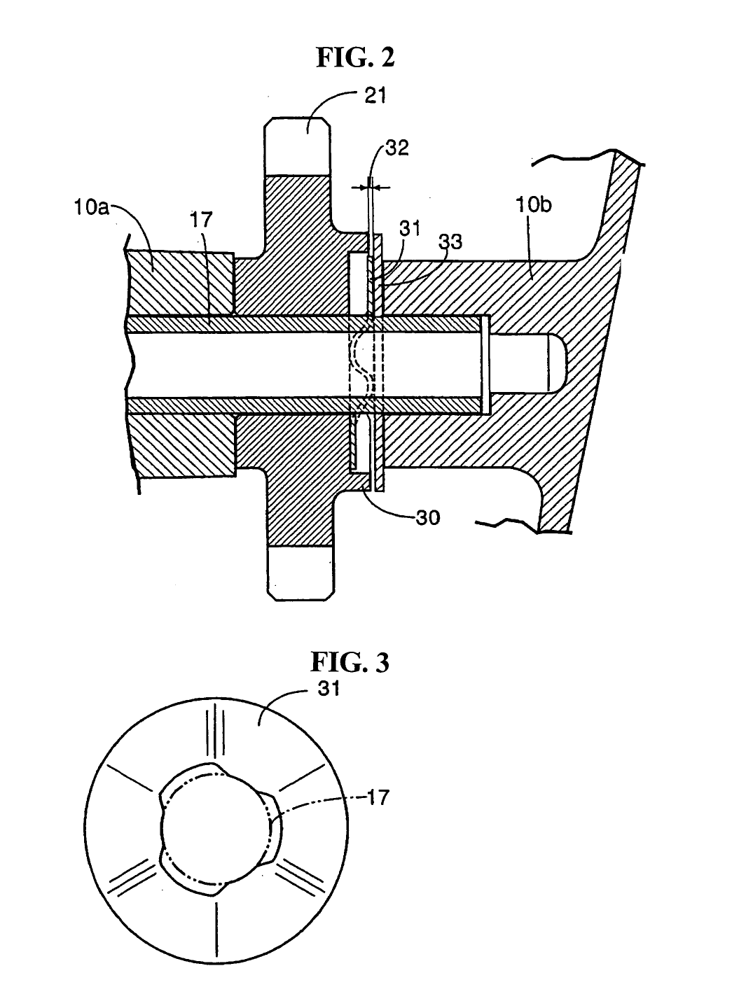

The present invention will hereinafter be described with reference to the accompanying drawings. FIG. 1 is a longitudinal sectional view of a starting gear transmission device having a vibration-proof structure according to the present invention. FIG. 2 is an enlarged view of a vibration-proof structure in the above starting gear transmission device. FIG. 3 is a plan view of a wave washer in the vibration-proof structure of the present invention.

As seen in FIG. 1, an engine body 10 includes a crankcase of an engine for a motorcycle. A crankshaft 11 is stored and supported in the body, and a starter motor 12 is mounted to the outer surface of the engine body 10 at a position corresponding to the center portion in an axial direction of the crankshaft 11 in such a manner that its output shaft 13 is parallel to the crankshaft 11. Imbalances in engine weight between right and left sides typically caused by the starter motor 12 are prevented by this positioning of the starter motor 12.

The output shaft 13 of the starter motor 12 is linked to one end of the crankshaft 11 by the starting gear transmission device 15. The starting gear transmission device 15 includes a long first shaft 16 and a short second shaft 17 supported by the opposed first and second fixed walls 10a and 10b of the engine body 10 between the output shaft 13 of the starter motor 12 and the crankshaft 11. A large-diameter gear 19 engaged with a pinion 18 at the external end of the output shaft 13 is fitted onto one end side of the first shaft 16, and a small-diameter gear 20 engaged with an idle gear 21 having an intermediate diameter rotatably supported by the second shaft 17 is fitted onto the other end side of the first shaft 16.

The idle gear 21 is engaged with a ring gear 22 having the largest diameter fitted onto one end portion of the crankshaft 11 through an overrunning clutch 23. Therefore, at the start of the starter motor 12, the revolution of the output shaft 13 is decelerated in three stages by the pinion 18 and the large-diameter gear 19, the small-diameter gear 20 and the idle gear 21, and the idle gear 21 and the ring gear 22. Accordingly, the revolution of the output shaft 13 is transmitted to the crankshaft 11 through the overrunning clutch 23 to start the engine.

The overrunning clutch 23 normally includes a crank outer 25 having a hub 25a fitted onto one end portion of the crankshaft 11 by spline engagement, a crank inner 26 rotatably supported by a needle bearing 27 around the hub 25a, and sprags 28, interposed between the crank outer 25 and the crank inner 26 for connecting the crank outer 25 and the crank inner 26 by standing up during the normal rotation of the crank inner 26. The above ring gear 22 is welded to the crank inner 26. Therefore, when the crankshaft 11 turns at a higher speed than the ring gear 22 along with the start of the engine, the sprags 28 fall to an inactivation position to cut off connection between the crank outer 25 and the crank inner 26.

A starting clutch C which is mounted to the input end portion of a gearbox input shaft (not shown) to be driven by the crankshaft 11 is situated on one side of the long first shaft 16 between the above large-diameter gear 19 and the small-diameter gear 20. Thus, it is possible to place the starting gear transmission device 15 and the starting clutch C in proximity to each other.

The vibration-proof structure of this starting gear transmission device 15 will be described in greater detail hereinafter with reference to FIG. 2 and FIG. 3. The above idle gear 21 turns on the second shaft 17 and can slide in the axial direction between the first and second fixed walls 10a and 10b. A wave washer 31 which is wavy in a peripheral direction is interposed between one end face of the idle gear 21 and a plane washer 33 placed on the end face of the second fixed wall 10b to surround the second shaft 17. The wave washer 31 is compressed by a predetermined amount between the end face of the idle gear 21 and the plane washer 33 placed on the end face of the second fixed wall 10b, whereby a predetermined set load for pressing the idle gear 21 toward the first fixed wall 10a is applied.

A cylindrical portion 30 surrounding this wave washer 31 is integrated with one end face of the idle gear 21 and when the idle gear 21 is contacted to the first fixed wall 10a, a predetermined space 32 is formed between the cylindrical portion 30 and the plane washer 33 in contact with the second fixed wall 10b. This space 32 serves as the bending margin of the wave washer 31 so that the bending amount of the wave washer 31 is regulated by contact between the cylindrical portion 30 and the second fixing wall 10b through the plane washer 33.

When the idle gear 21 vibrates on the second shaft 17 in the axial direction by load variation or the like during the starting of the engine, e.g., during the operation of the starting gear transmission device 15, this vibration can be absorbed by the elastic deformation of the wave washer 31 in the axial direction. In this case, when the idle gear 21 is pressed toward the second fixed wall 10b side by an excessive thrust load, the wave washer 31 is bent by a predetermined amount corresponding to the above space 32 and then the idle gear 21 brings the cylindrical portion 30 into contact with the second fixed wall 10b through the plane washer 33, whereby the bending amount of the wave washer 31 is regulated to restrain the generation of excessive resiliency. Therefore, it is possible to prevent the amplification of the vibration of the idle gear 21 caused by the excessive resiliency. The suppression of the vibration of the above idle gear 21 can reduce the whole vibration of the starting gear transmission device 15. At the same time, the durability of the wave washer 31 can be improved.

In addition, the bending amount of the wave washer 31 can be regulated by an extremely simple structure that the cylindrical portion 30 for surrounding the wave washer 31 is provided on one end face of the idle gear 21 and a vibration-proof structure for the starting gear transmission device 15 can be provided at a low cost.

The present invention is not limited to the above embodiment and various changes may be made without departing from the scope of the present invention. For example, the cylindrical portion 30 surrounding the wave washer 31 may be formed on the second fixed wall 10b instead of the idle gear 21. In place of the wave washer 31, a Belleville spring or rubber washer may also be used.

The cylindrical portion surrounding the elastic member can be provided on one of the opposed end faces of the second fixed wall and the gear and is contacted to the other end face to regulate an increase of a predetermined value or more in the bending amount of the elastic member, thereby forming a regulating means, in addition to the first feature. Therefore, the above regulating means can be constructed with an extremely simple structure that the cylindrical portion is provided on one of the opposed end faces of the second fixed wall and the gear, thus making it possible to provide an inexpensive vibration-proof structure for a gear transmission device.

Further, since the gear is an idle gear which is supported by a shaft between the first and second fixed walls in such a manner that it can slide and turn freely, in addition to the first and second features, the vibration of the whole gear transmission device can be restrained by suppressing the vibration of the idle gear.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A gear transmission device comprising:
a pair of first and second fixed walls, said first and second fixed walls opposing each other with respect to an axial direction of a first gear shaft;
a first gear positioned on said first gear shaft between said first and second fixed walls, said first gear being axially moveable with respect to said first and second fixed walls;
a vibration-reducing structure having an elastic member being positioned between said first gear and said second fixed wall; and
a regulating device for regulating an increase of a bending amount of the elastic member being interposed between the first gear and the second fixed wall by a predetermined value.

2. The gear transmission device according to claim 1, further comprising a second shaft having a relatively large diameter gear on a first end and a relatively small diameter gear on a second end, wherein said small diameter gear operatively engages said first gear positioned on said first gear shaft positioned between said first and second fixed walls.

3. The gear transmission device according to claim 2, further comprising a large diameter ring gear operatively engaged with said first gear, wherein said first gear is an idle gear and said first gear shaft is an idle gear shaft.

4. The gear transmission device according to claim 1, said regulating device including
a cylindrical portion being formed on a first opposed end face of the first gear and a planar surface on an end face of the second fixed wall, wherein said elastic member is surrounded by said planar surface and said cylindrical portion; and
said cylindrical portion is capable of operative contact with said planar end surface of said second end wall and regulating a bending amount of said elastic member to a predetermined amount.

5. The gear transmission device according to claim 3, said regulating device including
a cylindrical portion being formed on a first opposed end face of the first gear and a planar surface on an end face of the second fixed wall, wherein said elastic member is surrounded by said planar surface and said cylindrical portion; and
said cylindrical portion is capable of operative contact with said planar end surface of said second end wall and regulating a bending amount of said elastic member to a predetermined amount.

6. The gear transmission device according to claim 1, said regulating device including
a cylindrical portion being formed on a first opposed end face of the second end wall and a planar surface on an end face of the first gear, wherein said elastic member is surrounded by said planar surface and said cylindrical portion; and
said cylindrical portion is capable of operative contact with said planar end surface of said first gear and regulating a bending amount of said elastic member to a predetermined amount.

7. The gear transmission device according to claim 2, said regulating device including
a cylindrical portion being formed on a first opposed end face of the second end wall and a planar surface on an end face of the first gear, wherein said elastic member is surrounded by said planar surface and said cylindrical portion; and
said cylindrical portion is capable of operative contact with said planar end surface of said first gear and regulating a bending amount of said elastic member to a predetermined amount.

8. The gear transmission device according to claim 1, wherein said elastic member is a wave washer, a Belleville spring or a rubber washer.

9. The gear transmission device according to claim 8, wherein said elastic member is a wave washer.

10. The gear transmission device according to claim 3, wherein said elastic member is a wave washer, a Belleville spring or a rubber washer.

11. The gear transmission device according to claim 10, wherein said elastic member is a wave washer.

12. The gear transmission device according to claim 5, wherein said elastic member is a wave washer, a Belleville spring or a rubber washer.

13. The gear transmission device according to claim 12, wherein said elastic member is a wave washer.

14. The gear transmission device according to claim 7, wherein said elastic member is a wave washer, a Belleville spring or a rubber washer.

15. The gear transmission device according to claim 14, wherein said elastic member is a wave washer.

16. The gear transmission device according to claim 12, fuirther comprising a plane washer disposed in a position opposite to said cylindrical portion and surrounding said elastic member.
